(19) United States
(12) Patent Application Publication
(10) Pub. No.: US 2015/0217320 A1
(43) Pub. Date: Aug. 6, 2015

(54) TELESCOPIC WAND

(71) Applicant: ROBERT L. BONZER, Boise, ID (US)

(72) Inventor: ROBERT L. BONZER, Boise, ID (US)

(21) Appl. No.: 14/172,339

(22) Filed: Feb. 4, 2014

(51) Int. Cl. B05B 15/06; A01G 25/14

(52) U.S. Cl. CPC B05B 15/068; A01G 25/14

(57) ABSTRACT

A telescopic water wand utilizing an exterior tube, an interior tube, a seal and a handle. The handle is mounted at one end of the exterior tube where the interior enters the exterior tube. The handle includes a pressable button that depresses a spraying on one end and lifts a locking pin on the other end. The locking pin interacts with a series of indentations on the interior tube allowing a user to select a desirable length of the water wand. The fluid tight seal is achieved by a sealing piece that utilizes two separate sections: a smaller section that fits within the interior tube and a larger section that fits with the exterior tube. Each section has one or more external o-rings to create a seal with the associated tube.

### TECHNICAL FIELD

The presently disclosed and claimed inventive concepts generally relate to a device for extendable wands, and more particularly to extendable wands capable of passing water.

### BACKGROUND

Water wands are useful in a wide variety of operations. Water wands are commonly used for watering plants that are elevated or otherwise difficult to reach with a hand-held water pot or a short spray nozzle. Water wands are also used for cleaning difficult to reach places including RVs, cars, and house gutters. These tasks are generally accomplished by using water wands consisting of an elongate tube section with a spray nozzle on one end and a hose connector on the opposing end.

Fixed length water wands can be difficult to use for distances different than the length of the wand. For example, using a water wand ten feet in length to water a plant that is only two feet out of reach can become difficult as the weight of the hose and water pulls the hose end of the wand downward. Alternatively, using a water wand four feet in length will make it difficult for a user to water a plant that is six feet away.

Most consumers prefer having a single water wand, rather than multiple water wands of various lengths. Thus, retractable water wands were developed. Retractable wands utilize various methods to facilitate extending and retracting the water wand while maintaining a fluid tight seal. For example this includes a rotating locking mechanism incorporating a pressure washer.

The rotating lock mechanism is shown for example in U.S. Pat. No. 6,619,570. This patent discloses an extendable water wand where the locking mechanism is a rotating ring that compresses a pressure washer into the space between an inside and outside tube. When the locking handle is rotated in one direction the compression force is removed from the pressure washer and the tubes are allowed to slide past each other. When the locking mechanism is rotated in the other direction a force is applied to the pressure washer and the pressure washer creates a fluid tight seal between the interior and exterior tubes. One problem with this type of system is that the pressure washers can become stuck between the two tubes. This can occur when the locking mechanism is rotated too tightly or potentially when the device is left in a locked position for an extended period of time or through wear in the system. Once stuck, the washer can be difficult or impossible to release, rendering the sliding capability inoperative.

A second problem with these rotating style locking system is that they can be difficult for certain users to operate. For example, a person with arthritis may have difficulty unlocking the device to allow the tubes to slide. Further, a person with arthritis may have difficulty sufficiently tightening the locking mechanism to create the fluid tight seal. In either of these scenarios the water wand is difficult to use.

Another issue with rotating style extendable water wands is that some people may have insufficient strength to loosen or tighten the locking mechanism. For instance, if a strong person tightens the water wand it may become difficult for someone of lesser strength to release the locking mechanism.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concepts of the application, which is measured by the claims, nor is it intended to be limiting as to the scope of the inventive concepts in any way.

Still other features and advantages of the presently disclosed and claimed inventive concepts will become readily apparent to those skilled in this art from the following detailed description describing preferred embodiments of the inventive concepts, simply by way of illustration of the best mode contemplated by carrying out the inventive concepts. As will be realized, the inventive concepts are capable of modification in various obvious respects all without departing from the inventive concepts. Accordingly, the drawings and description of the preferred embodiments are to be regarded as illustrative in nature, and not as restrictive in nature.

It is an object of the present inventive concepts to solve the problems associated with the prior art water wand. These problems include the difficulty of use by persons having arthritis, difficulty caused by users of different strengths, as well as the potential of the water wand to become stuck in a single position. This design addresses these potential issues surrounding the prior art in various ways. For instance, the use of a locking pin lever and spring assembly results in a fixed amount of pressure or strength required to operate the locking mechanism. In this way, if a strong person uses the water wand followed by a weaker or arthritic person, the amount of force required for operation does not change based on the strength of the original user. Additionally, because a user cannot exert excessive force on the locking mechanism it is not possible for the water wand to become stuck in a single position. This is further accomplished by the pin not being precision fitted into the locking holes, allowing for limited movement allows for the pin to not become seized or fixed in a single locking hole.

The described and disclosed telescoping water wand has a handle placed at the junction of two tubes, an interior and exterior tube. The interior tube is configured to slide within the exterior tube. There is a slideable seal within that creates a fluid tight seal between the interior and exterior tubes.

The seal is be made of a tubular piece comprised of two sections of tube have different diameters connected together. A smaller diameter section of tube utilizing one or more exterior o-rings fits within the interior tube while a larger diameter section of the sealing member utilizes one or more o-rings to create a fluid tight seal with the exterior tube.

Locking telescopic functionality is achieved through the use of a series of indentations on the interior tube. These indentations are designed to receive a locking pin that is attached to a handle. The indentations preferably do not pass completely through the interior tube, although that is not necessary if other sealing methods are used. The handle is constructed for push-button operation that will depress a spring on one end of the button and the opposite end will retract the locking pin that is situated inside of one of the indentations. The use of a spring biases the handle into a locked position to secure the water wand at a length selected by the user.

### BRIEF DESCRIPTION OF THE DRAWINGS

FIG. 1 is a cross-sectional, elevated view of a preferred embodiment of the inventive concepts.

FIG. 2 is an exploded parts diagram of a preferred embodiment of the inventive concepts.

FIG. 3 is an elevated view of a sliding seal consistent with a preferred embodiment of the inventive concepts.

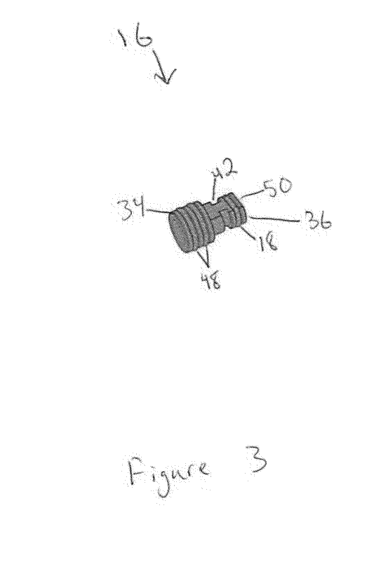

### DEFINITIONS

In the following description and in the figures, like elements are identified with like reference numerals.

The use of “e.g.,” “etc,” and “or” indicates non-exclusive alternatives without limitation unless otherwise noted.

The use of “including” means “including, but not limited to,” unless otherwise noted.

The terms “water” and “fluid” are generally used interchangeably, with the terms generally referencing fluids (such as water) that can pass through the wand.

### DETAILED DESCRIPTION OF THE EXEMPLARY EMBODIMENTS

While the presently disclosed inventive concepts are susceptible of various modifications and alternative constructions, certain illustrated embodiments thereof have been shown in the drawings and will be described below in detail. It should be understood, however, that there is no intention to limit the inventive concepts to the specific form disclosed, but, on the contrary, the presently disclosed and claimed inventive concepts is to cover all modifications, alternative constructions, and equivalents falling within the spirit and scope of the inventive concepts as defined in the claims.

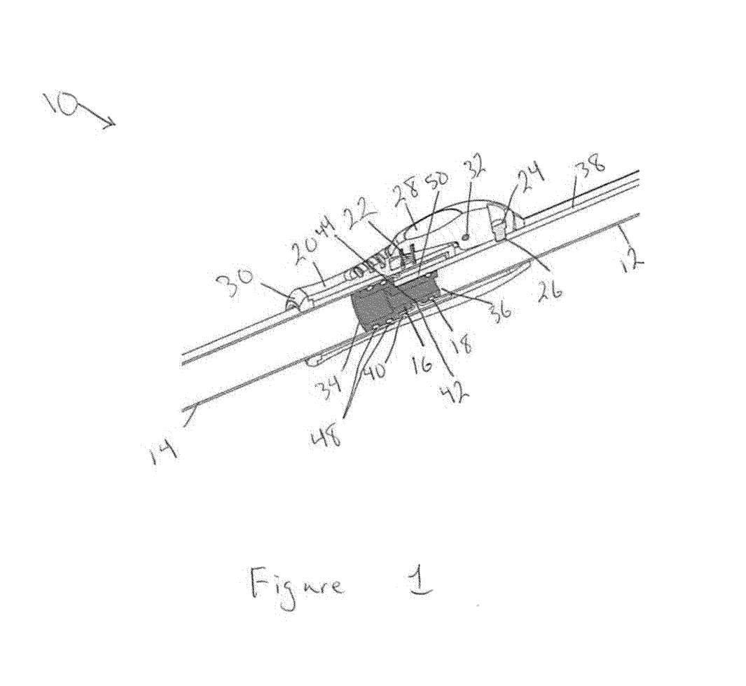

FIG. 1 illustrates a cross-section view of a preferred embodiment of telescoping wand 10. Telescoping wand 10 allows a user to attach a liquid source to one end of telescoping wand 10 and direct a forced flow of liquid through the opposite end of telescoping wand 10. This configuration allows the user to reach areas that would otherwise be unreachable, such as vehicle tops, gutters, and hanging plants. Telescoping wand 10 has an interior tube 12 and an exterior tube 14 which are configured so that interior tube 12 can slide within exterior tube 14. Each tube is hollow to allow passage of a liquid. On the end of exterior tube 14 farthest from interior tube 12 is a connection fitting to form a fluid tight seal between exterior tube 14 and a liquid source, such as a garden hose. On the end of interior tube 12 opposite of exterior tube 14 is a connection fitting that can form a fluid tight seal with an end piece, such as a water nozzle, including a compression nozzle or rotating nozzle. While both interior tube 12 and exterior tube 14 are shown being mostly circular outer surfaces, other shapes such as rectangular, hexagonal, or other shapes are acceptable.

Sliding seal 16 forms a fluid tight connection between exterior tube 14 and interior tube 12. Sliding seal 16 has first section 34 that has two large o-rings 48 extending around its exterior. While two o-rings are shown, a single o-ring is acceptable, as well as other methods of creating a moveable seal between two hollow tubes. First section 34 is constructed to move large o-rings 48 into exterior tube 14 to create a fluid tight seal. Sliding seal 16 also has a second section 36 that is connected to the first section 34 wherein second section 36 incorporates small o-ring 18 around its exterior surface. Second section 36 of sliding seal 16 is designed to push small o-ring 18 into interior tube 12 to create a fluid tight seal. Similar to large o-rings 48, small o-ring 18 is replaceable with additional o-rings or alternative methods of sealing the connection between the small section 36 and interior tube 12. Exterior tube 14 incorporates slide stop ridge 40 to stop sliding seal 16 from passing beyond a preselected point. Slide stop ridge 40 reduces the inside diameter of exterior tube 14 to be smaller than first section 34, thus preventing sliding seal 16 from sliding beyond slide stop ridge 40. While a ridge extending entirely around exterior tube 14 is preferred, other designs including a single protuberance or multiple protuberances are foreseeable. Sliding seal 16 can be held inside interior tube 12 in a variety of ways, including friction fittings or glue, but in a preferred embodiment interior tube 12 has seal retention indentation 42 that is aligned with seal retention depression 44 on sliding seal 16. Seal retention indentation 42 is formed by inserting the sliding seal 16 into interior tube 12 and machining interior tube 12 at a location adjacent to seal retention depression 44.

The handle 20 surrounds the connection point of interior tube 12 and exterior tube 14, and extends in both directions, along exterior tube 14 and interior tube 12, allowing a user to securely grasp telescopic wand 10 during use or while extending or retracting interior tube 12. Handle 20 incorporates handle pin 32 to attach pin release lever 28 to handle 20. Attached to pin release lever 28 on the end extending in the same direction as interior tube 12 is locking pin 24. Locking pin 24 is configured to extend slightly beyond outside of pin release lever 28 and interact with locking holes 26. Connected to pin release lever 28 on the end extending toward to exterior tube 14 is spring 22. In this configuration spring 22 biases the pin release lever 28 to force locking pin 24 into locking holes 26 when the user is not placing any pressure on pin release lever 28 near spring 22. Handle 20 incorporates end cap 30 for improved aesthetics and ergonomic functionality of handle 20. While spring 22 is used in the depicted embodiment, other devices can be used to bias the pin release lever 28. Other devices include a spring wrapped around handle pin, similar to a mousetrap, a compressible ball, or stretchable members attached to pin release lever 28 on the end with locking pin 24 including rubber bands or tension springs.

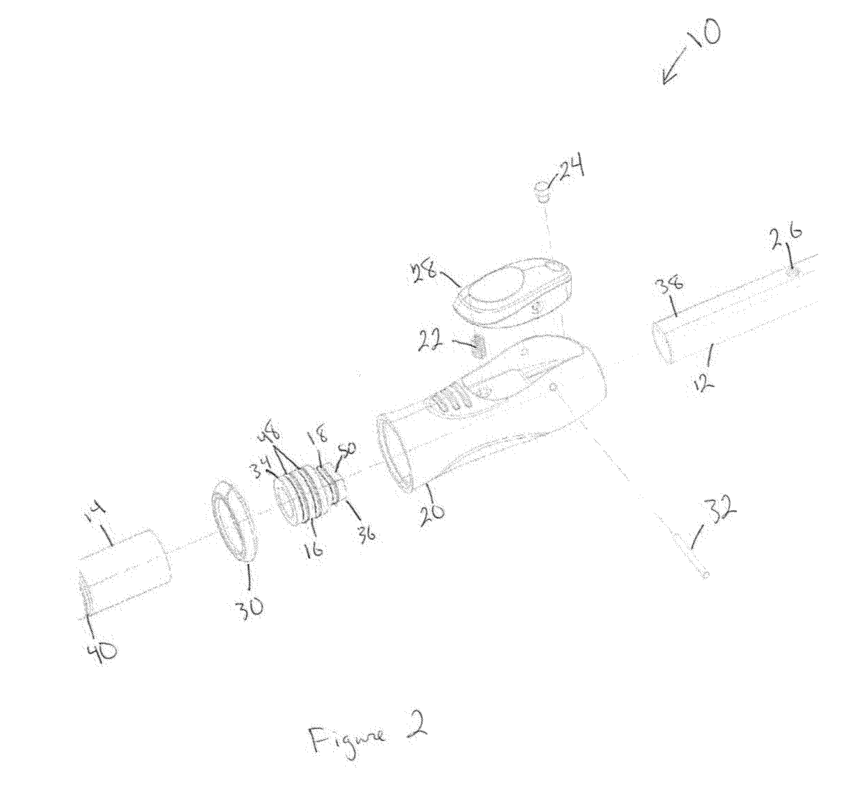

FIG. 2 shows an exploded parts diagram of telescopic wand 10. In this embodiment interior tube 12 is shown having locking holes 26 located on flat section 38 of interior tube 12. Although not required, inclusion of flat section 38 is preferred to serve as a location for locking hole 26 and prevent rotation of interior tube 12 to ensure that upon extending or retracting interior tube 12 locking hole 26 is aligned with locking pin 24. Flat section 38 of interior tube 12 corresponds with seal flat section 46 on sliding seal 16. Handle pin 32 is shown extracted from handle 20. Handle pin 32 is inserted through the holes in the handle 20 and through the corresponding holes in pin release lever 28 and then through a second hole in handle 20 in order to lock pin release lever 28 into a position such that one end of pin release lever 28, when pressed by a user, causes pin release lever 28 to rotate around handle pin 32 to depress the spring 20 and remove locking pin 24 from locking hole 26. Once the user releases the pin release lever 28, spring 22 extends to return pin release lever 28 to the normal position with locking pin 24 pressed against interior tube 12 or into locking hole 26.

The use of spring 22 eliminates the need for a user force input in order to create a fluid tight seal between interior tube 12 and exterior tube 14. A user can apply a consistent amount of force each time the mechanism is operated. This assists the user in locking the device and prevents excessive force being used to lock the device. This advantage further extends to users having arthritis or otherwise limited gripping and/or rotating strength.

Sliding seal 16 and handle 20 separate the locking force from the sealing force. The seal remains in place and functions without any force input from the user. The sliding seal cannot become stuck between the interior tube 12 and exterior tube 14 because a user is not able to place excessive force on the device.

The telescopic wand 10 can be configured to automatically extend. This is performed by activating an attached water source attached to the water wand at a first end of the water wand thus pressurizing the water wand and extending the second end of the water wand. In the depicted embodiment, the user depresses pin release lever 28 thus removing locking pin 24 from locking hole 26 and extending water wand due to water (or fluid) pressure within the wand. The then can release pin lever 28 when the water wand reaches a desired length. Alternatively, the user can press and release pin release lever 28 until the desired length is achieved, thus extending the water wand incrementally. The current design simplifies operation of a telescoping wand and decreases the amount of force, both gripping and rotating forces required, allowing for increased comfort of use for users of different strength.

What is claimed is:

1. A telescoping wand comprising:
A first tube having a proximate end and a distal end and an inside surface and an outside surface and a second tube having a proximate end and a distal end and an inside surface and an outside surface wherein said proximate end of said second tube is located within said distal end of said first tube and configured to slide within said first tube and said second tube having one or more indentations configured to receive a locking pin;
A fluid tight seal between said first tube and said second tube;
A handle surrounding said distal end of said first tube and said proximate end of said second tube, said handle comprising a lever having a first end and a second end extending substantially parallel to said first tube, said lever being rotatably attached to said handle;
A locking pin configured to fit within said indentations attached to said second end of said lever and a means for biasing said lever into a position such that said locking pin is engaged with said indentations;
Said lever configured to remove said locking pin from said indentations to allow said interior tube to slide within said exterior tube to an alternative desirable locking indentation.

2. The telescoping water wand of claim one wherein said means for biasing is an elastically compressible member attached to said first end of said lever.

3. The telescoping water wand of claim two wherein said elastically compressible member is a spring.

4. The telescoping water wand of claim one wherein said means for biasing is an elastically extendable member attached to said second end of said lever.

5. The telescoping water wand of claim one wherein said fluid tight seal comprises:
A first section configured to slideably fit within said first tube connected to a second section configured to fit within said second tube;
Said first section having at least one external groove for accepting an o-ring and an o-ring within each groove configured to create a fluid tight seal with said first tube;
Said second section having at least one external groove for accepting an o-ring and an o-ring within each groove configured to create a fluid tight seal with said second tube;

6. The telescoping water wand of claim one wherein said fluid tight seal comprises:
A section formed as a part of said second tube having at least one groove on said section's external surface wherein said groove is configured to accept an o-ring, and an o-ring within said groove configured to create an airtight seal with said first tube.

7. The telescoping water wand of claim one wherein said fluid tight seal comprises:
the proximate end of said second tube having a sealing section of exterior diameter near that of the interior diameter of said first tube; said section being long enough to create a fluid tight seal;

8. The telescoping water wand of claim 4 wherein said fluid tight seal comprises:
One or more o-rings extending around the exterior surface of said sealing section;
Said sealing section configured to exert a sufficient force on said o-rings to create a fluid tight seal between said o-rings and said first tube.

9. The telescoping water wand of claim one wherein said second tube has at least one flat side for placement of said locking indentations and said handle has at least one corresponding flat surface to engage said flat side on said interior tube to prevent rotation of said interior tube.
